(19) United States
(12) Patent Application Publication
(10) Pub. No.: US 2026/0154450 A1
(43) Pub. Date: Jun. 4, 2026

(54) DECOUPLED SECURE DATA HANDLING FOR GENERATIVE AI APPLICATIONS

(71) Applicant: Merlyn Mind, Inc., New York, NY (US)

(72) Inventors: TAMER ABUELSAAD, Fishkill, NY (US); DEEPAK AKKIL, Helsinki (FI); RAVINDRANATH KOKKU, Yorktown Heights, NY (US); PRASENJIT DEY, Kolkata (IN)

(21) Appl. No.: 19/196,391

(22) Filed: May 1, 2025

(30) Foreign Application Priority Data
Dec. 3, 2024 (IN) 202441095197

(51) Int. Cl. G06F 21/62

(52) U.S. Cl. CPC G06F 21/6254; G06F 2221/2141

(57) ABSTRACT

A system and related methods for preserving data privacy in intelligent task performance is disclosed. The system is programmed to receive a request for performing an online task. The system is programmed to prepare inputs based on the request to an external device that facilitates performance of the online task but is not subject to the access control of the system. The preparation includes determining access restrictions on relevant data and obfuscating sensitive data with restricted access based on the online task. The system is programmed to then transmit the inputs to an external system and receive outputs from the external system. The system is programmed to then prepare final output data based on the outputs, including recovering the sensitive data and taking additional steps to complete the online task. The system is programmed to then transmit the final output data in response to the request.

### RELATED APPLICATIONS

This application claims priority benefit under 35 U.S.C. § 119 (a)-(d) to Indian Patent Application No. 202441095197 titled “DECOUPLED SECURE DATA HANDLING FOR GENERATIVE AI APPLICATIONS” and filed on Dec. 3, 2024, the entire contents of which are hereby incorporated by reference as if fully set forth herein.

### TECHNICAL FIELD

The present disclosure relates to data obfuscation and automatic task performance, and more particularly preserving data privacy across security barriers in performing online tasks.

### BACKGROUND

Today, as technology becomes more advanced, more online tasks are being performed automatically. The tasks to be performed for user accounts frequently involve data of a private or confidential nature that is not expected to leave the secure environment. Now, more demanding tasks can be performed by more complex computer systems. However, such complex computer systems are often external rather than within a proprietary secure environment. For example, the advent of large language models (LLMs) enables performance of more demanding tasks, where many LLMs are currently hosted by third-party servers. It will be helpful to be able to utilize powerful external computer systems to efficiently perform online tasks for user accounts without sacrificing any protection of sensitive data.

### SUMMARY

The appended claims may serve as a summary of the invention.

### BRIEF DESCRIPTION OF THE DRAWINGS

Example embodiments will now be described by way of non-limiting examples with reference to the accompanying drawings, in which:

FIG. 1 illustrates an example networked computer system in which various embodiments may be practiced.

FIG. 2 illustrates an electronic form to be filled out to complete a requested task.

FIG. 3 illustrates an example portion of a prompt for an LLM regarding filling out an electronic form.

FIG. 4 illustrates an example portion of output data produced by an LLM regarding filling out an electronic form.

FIG. 5 illustrates another example portion of output data produced by an LLM regarding filling out an electronic form.

FIG. 6 illustrates a process of preserving data privacy in intelligent task performance in accordance with disclosed embodiments.

FIG. 7 illustrates an example computer system upon which various embodiments may be implemented.

### DETAILED DESCRIPTION OF CERTAIN EMBODIMENTS

In the following description, for the purposes of explanation, numerous specific details are set forth in order to provide a thorough understanding of the example embodiment(s) of the present invention. It will be apparent, however, that the example embodiment(s) may be practiced without these specific details. In other instances, well-known structures and devices are shown in block diagram form in order to avoid unnecessarily obscuring the example embodiment(s).

### 1. General Overview

A system and related methods for preserving data privacy in intelligent task performance is disclosed. The system is programmed to receive a request for performing an online task. The system is programmed to prepare inputs based on the request to an external device that facilitates performance of the online task but is not subject to the access control of the system. The preparation includes determining access restrictions on relevant data and obfuscating sensitive data with restricted access based on the online task. The system is programmed to then transmit the inputs to an external system and receive outputs from the external system. The system is programmed to then prepare final output data based on the outputs, including recovering the sensitive data and taking additional steps to complete the online task. The system is programmed to then transmit the final output data in response to the request.

In some embodiments, the system is programmed or configured to receive a request for performing an online task from a user device associated with a user account. For example, the online task can be filing out an electronic form. The electronic form could be represented as an image or identified by an address, such as a uniform resource locator (URL).

In some embodiments, the system is programmed to determine how to perform the online task based on existing task specifications or information included in the request. Such determination can include identifying the data required for performing the online task and associated access restrictions based on existing access control rules. Such determination can also include identifying any computer application to be used to facilitate performance of the online task. For example, it can be determined that the electronic form is to be filled out with information associated with the user account, any such information not included in the request is to be retrieved from appropriate databases, and a portion of such information (e.g., social security number) is confidential in nature. It can be further determined that an LLM hosted by an external device that is not subject to the access control rules can be used to facilitate filling out the form. Given appropriate prompts, the LLM can efficiently analyze the electronic form and determine how to fill it out.

In some embodiments, the system is programmed to prepare inputs to a chosen computer application. Such preparation generally includes obfuscating any sensitive data, which has access restrictions, based on the online task and storing a transformation between original values and obfuscated values of the sensitive data. Specifically, the system is programmed to determine how to obfuscate the sensitive data by analyzing available obfuscation techniques with respect to the nature of the sensitive data and the nature of the online task. For example, when the sensitive data calls for complete transformation and the online task calls for metadata that reveals the data type but not the data content, the metadata of the sensitive data can be used as obfuscated values of the sensitive data. Filling out an online form serves as an example of such an online task. For an LLM, the inputs can also include an appropriate prompt based on the task specifications.

In some embodiments, the system is programmed to feed the inputs to the application and receive outputs produced by the application. The system is programmed to then complete the online task based on the outputs to generate final output data. Completing the online task generally includes restoring the sensitive data based on the transformation. Completing the online task can include further processing the outputs based on the task specifications or additional access control rules. For example, the task specifications can instruct an LLM to provide instructions for filling out an electronic form, and the outputs from the LLM thus contain instructions for filing out an electronic form. The instructions can then be followed to actually fill out the electronic form. The access control rules can indicate that while certain sensitive data (e.g., social security number) should be completely masked when presented to any party other than the user account, it should also be partially masked when presented to the user account. Such sensitive data in the filled-out form can then be obfuscated accordingly in the final output data. The system is programmed to then transmit the final output data to the user device as a response to the request.

The system disclosed herein has several technical benefits. By performing data obfuscation, the system affords protection to sensitive data without settling with inefficient approaches of performing an online task. By choosing data obfuscation techniques based on the online task to be performed, the system further increases the efficiency and effectiveness of performing the online task, as appropriate data obfuscation techniques can reduce time and space requirements and facilitate performance of the online task. By implementing adequate access control over data involved in the online task and obfuscating data depending on how the data is accessed by computer applications or user accounts, the system further achieves end-to-end data security for performing the online task.

### 2. Example Computing Environments

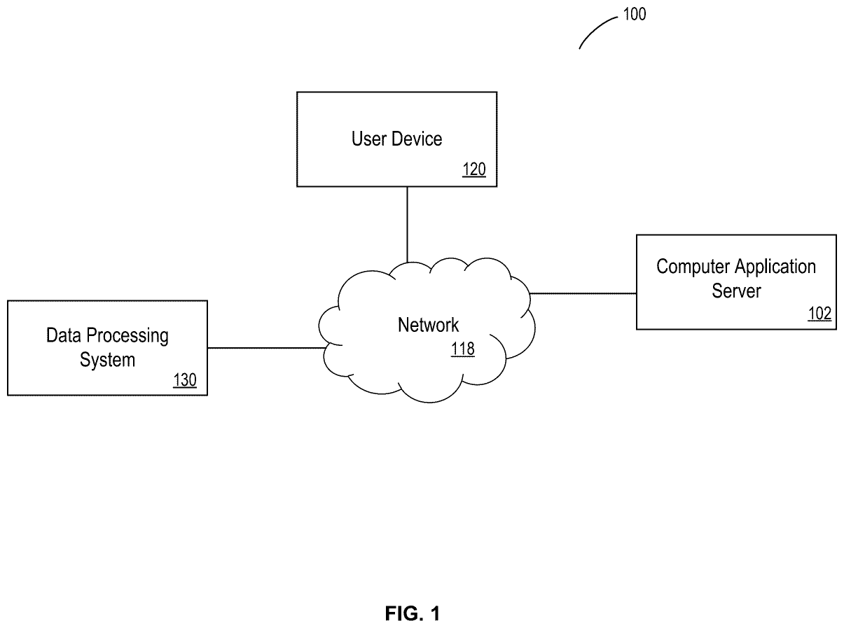

FIG. 1 illustrates an example networked computer system in which various embodiments may be practiced. FIG. 1 is shown in simplified, schematic format for purposes of illustrating a clear example and other embodiments may include more, fewer, or different elements.

In some embodiments, a networked computer system 100 comprises a computer application server (“server”) 102, a user device 120, and a data processing system 130, which are communicatively coupled through direct physical connections or via a network 118.

In some embodiments, the user device 120 is programmed or configured to prepare a request for performing an online task for a user account associated with the user device, including in the request relevant information to identify the online task and any data needed to perform the online task. For example, the online task can be filling out an electronic form for the user account or finding a message in an email inbox associated with a specific user account. The user device 120 can be further programmed to. submit the request and receive a result of performing the online task. The user device 120 node can comprise a personal computing device that has an integrated output device or is coupled to an output device, such as a desktop computer, laptop computer, or tablet computer.

In some embodiments, the data processing system 130 is programmed or configured to process data using LLMs having various capabilities, such as summarization, comparison, or inference, or other machine learning models. The data processing system 130 can be configured to receive prompts or additional inputs for the data processing and transmit a result of the data processing based on the prompts or additional inputs. The data processing system 130 can comprise any centralized or distributed computing facility with sufficient computing power in data processing, data storage, and network communication for performing the above-mentioned functions.

In some embodiments, the server 102 is programmed or configured to determine how to perform an online task, identify any sensitive data needed to perform the online task, and further determine how to transform the sensitive data based on the task. The sensitive data can be securely encoded in the request or retrievable by the server 102 from a local or another secure location. The server is further programmed to perform the online task, including communicating with an external, complex computer system that can facilitate performance of the online task, and transmit a result of performing the online task. The server 102 can comprise any centralized or distributed computing facility with sufficient computing power in data processing, data storage, and network communication for performing the above-mentioned functions.

The network 118 may be implemented by any medium or mechanism that provides for the exchange of data between the various elements of FIG. 1. Examples of the network 118 include, without limitation, one or more of a cellular network, communicatively coupled with a data connection to the computing devices over a cellular antenna, a near-field communication (NFC) network, a Local Area Network (LAN), a Wide Area Network (WAN), or the Internet, a terrestrial or satellite link.

In some embodiments, the server 102 is programmed to receive a request for performing an online task from the user device 120. The server 102 is programmed to then determine that performance the online task is to be facilitated by the data processing system 130, which is external to the secure environment provided by the server 102. The server 102 is programmed to next generate input data to the data processing system 130, including transforming any sensitive data based on the online task. The server 102 is programmed to then transmit the input data to the data processing system 130 and receive the output data form the data processing system 130. Furthermore, the server 102 is programmed to create final output data based on the output data, including recovering any sensitive data, and transmit the final output data to the user device 120 in response to the request.

### 3. Functional Descriptions

### 3.1. Processing Requests to Perform Tasks

In some embodiments, the server 102 is programmed to receive a request for performing an online task from a client device associated with a user account, such as filling out an electronic form on behalf of the user account or finding a specific message in an email inbox associated with the user account. The request can be in a specific format, such as including a task code and certain input data for the task based on predetermined task specifications. The request can also be in natural language, such as “Fill out this online application for this school using the data I provided for another school.”, and converted into the specific format using existing natural language processing methods or other artificial intelligence techniques.

In some embodiments, the server 102 is programmed to determine the set of digital items as input data to the task and the set of applications for performing the task to generate the output data, based on the request, additional user input, or the task specifications. As an example, for completing an electronic form, the set of digital items can include the form and at least a portion of a profile of the user account, which has basic types of information regarding the user account. Filling out the electronic form can be performed using an LLM. The request can include any amount of data, such as merely the identifier of the user account that can be used to look up the profile saved as account data or a combination with other digital items that can be included in the profile or are specifically required for the electronic form. As another example, for finding a specific message in an email inbox, the set of digital items can include at least a portion of the email inbox and key attributes of the specific message. Searching for a specific message can be performed using a known search method or an LLM via a general Web agent. Any of the set of digital items that is missing can be further requested from the client device or automatically looked up in a local memory based on the task specifications.

In some embodiments, the server 102 is programmed to determine how the set of digital items can be accessed by the user account and the set of applications based on metadata of the set of digital items or separate access control rules. The metadata and access control rules define access permissions and could come from the client device, local databases, or other data sources. In general, access permissions can be specified at various levels. The access permissions can be set for specific user accounts, user group accounts, or organization accounts, or for specific data types, documents, applications, or computer devices. The access permissions generally indicate to which entity access is granted and what type of access is granted based on privacy concerns, business requirements, or other factors. For example, in terms of email, the email address, personal information within the email body, an entire email message, or all email messages with a particular label could be marked private and thus not readily sharable with external applications. Such labels can be inserted into actual data (e.g., tags in HyperText Markup Language (HTML) documents) or linked to the actual data (e.g., priority values assigned to an email message) by authors or additional application based on specific data classification rules. For further example, data stored on some storage servers coupled to the server 102 can be accessible to only user accounts that can be properly authenticated by the storage servers.

Therefore, the server 102 is programmed to analyze all access permissions associated with the user account, the set of applications, and the set of digital items or their properties, such as the owner account or the storage device, to determine the access permissions governing access to the set of digital items by the user account and the set of applications. For example, it can be determined that the user account is not entitled to find a specific message in the email inbox of another user account. When the user account does not have proper access to any digital item in the set of digital items for performing the task, the request can be partially or fully denied, and that digital item can be excluded from the performance of the task. When the set of applications is not permitted to access any digital item of the set of digital items, the digital item is considered as sensitive data for the set of applications.

### 3.2. Desensitizing Input Data for Tasks

In some embodiments, the server 102 is programmed to obfuscate any sensitive data based on access control rules to enable the performance of the task using obfuscated data. For example, an access control rule can indicate that when a digital item is beyond an atomic level corresponding to a database column, granting no read permission to the digital item would cause the digital item to be excluded rather than obfuscated. As a result, an email address may be obfuscated, and the obfuscated version would be made readable, while an email message would simply be excluded from review without undergoing an obfuscation process.

In some embodiments, the server 102 can be programmed to maintain a mapping between the original value and the obfuscated value for a digital item. Instead of actual values, the mapping can specify a data type and a function that transforms data of the data type between an original value and a corresponding obfuscated value. The mapping can also include metadata for a mapping entry to further qualify the mapping entry. For example, the metadata can specify that only an occurrence of “Julie” that appears in the first four pages of a specific document or in an email message not sent by Julie would be transformed into the corresponding obfuscated value.

In some embodiments, the server 102 is programmed to choose one of various obfuscation techniques, which accomplish obfuscation by random data, default data, approximate data, corresponding metadata, or any unique identifier. For example, for the first name “Alexander” associated with a user account, the obfuscated value can be the name “Wendy” randomly chosen out of a dictionary, a default name, such as “Chris”, a nickname “Smiley” associated with the user account, an abbreviated name “Alex” as approximate data, a similar name “Alessandro” also as approximate data, an encompassing range of names “Adam” through Casey” as additional approximate data, the label “first name” as corresponding metadata, or a random series of symbols “@#Dt” as a unique identifier.

In some embodiments, different digital items can be associated with different privacy policies, which can specify a transformation rule or simply a degree of secrecy, where a higher degree of secrecy prefers stronger obfuscation. Thus, the server 102 can be programmed to employ an obfuscation technique for a digital item required by the transformation rule. Alternatively, the server 102 can be programmed to rank the obfuscation techniques, by degree of obfuscation, speed of implementation, nature of the task, or another criterion specified in the privacy policies, and choose a highly ranked obfuscation technique for the digital item. When a task can be automatically performed based on the metadata of a digital item, such as filling out an electronic form, the digital item can preferably be replaced by the corresponding metadata. When a task involves digital items that have identical metadata, such as different first names”, these digital items can preferably be replaced by distinct values that again have identical metadata. When a task requires processing a large amount of data, a digital item can preferably be replaced by an abbreviation or a random value that corresponds to a smaller amount of data than the original value. When a task involves a digital item whose original value matters in performing the task, the digital item can preferably be replaced by an encompassing range, while when the original value of the digital item does not matter in performing the task, the digital item can be replaced by a random value. When a task involves a digital item that has complex or embedded values, such as an image potentially including text, the digital item can preferably be replaced by random data to simplify the obfuscation process and reduce the chance of unnecessary exposure. Alternatively, embedded values can be identified, and appropriate obfuscation techniques can be applied as noted above.

For example, when the request is filling out an electronic form on behalf of a user account, any sensitive data used to fill out the electronic form can mainly come straight from a database, such as a table for user profiles. Therefore, the database column names can be used as the obfuscated values. For further example, when the request is finding a specific message in an email inbox, where the specific message is related to a certain activity performed by multiple parties, multiple pieces of sensitive data included in the email inbox can correspond to the same database column or no database column at all. Therefore, such sensitive data can be obfuscated by random data or approximate data.

### 3.3. Facilitating Performance of Tasks

In some embodiments, the server 102 is programmed to initiate or facilitate performance of the requested task using the set of applications. The server 102 can be programmed to utilize an LLM or another ML model to partially perform the task. For example, when the task is to fill out an electronic form, the ML model could be one trained to complete the specific electronic form, to complete any electronic form, or to provide instructions for completing an electronic form.

In some embodiments, the server 102 is programmed to generate input data for the ML model, such as a specifically formatted prompt or parameter values, based on the task specifications. Specifically, the input data would include obfuscated values instead of original values of sensitive data. The prompt would specify how to generate the output data based on the task specifications. For example, when the task is to fill out an electronic form and a representation of the electronic form is provided as the input data, the prompt could instruct generating instructions for inserting data into the electronic form or generating a representation of the filled-out electronic form where appropriate data is inserted into the electronic form. When the task is to find a specific message in an email inbox, the prompt could instruct returning the full content of the specific message or just an index of the specific message.

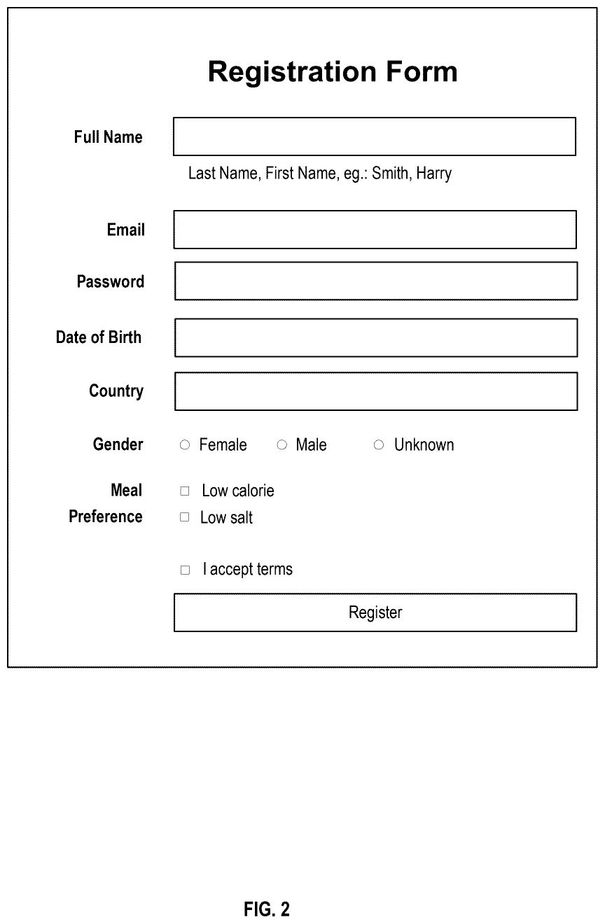

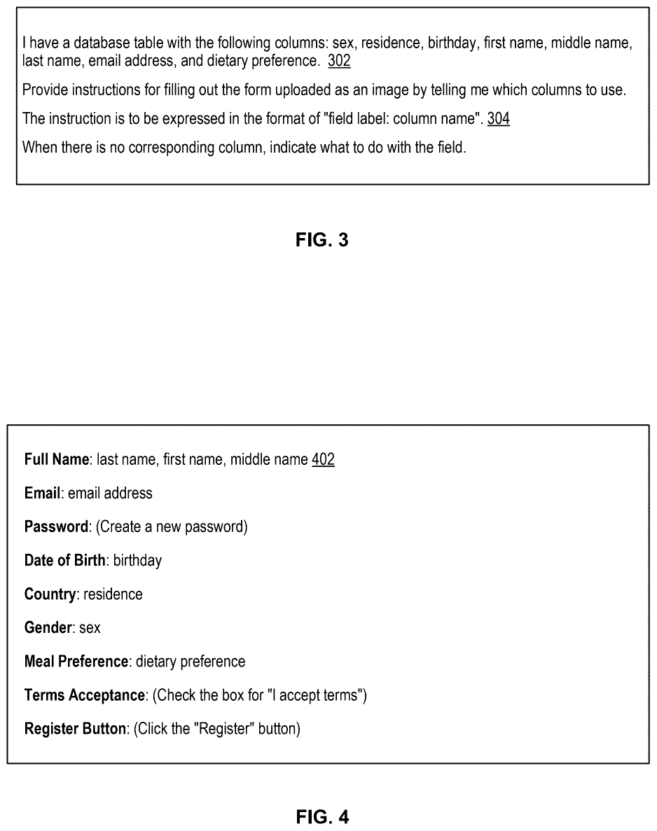

FIG. 2 illustrates an electronic form to be filled out to complete a requested task. In this example, the form is represented by an image, which can be identified by a URL or correspond to an HTML document, for instance. FIG. 3 illustrates an example portion of a prompt for an LLM regarding filling out an electronic form. In this example, the prompt is designed to obtain instructions for filling out the electronic form. The prompt includes a statement 302 with a list of metadata items for personal data considered as sensitive data. Such a list of metadata items could be a fixed list (e.g., all columns of a predetermined database table) or a specific list of obfuscated values based on the request. The prompt also includes a statement 304 that specifies the output format to facilitate automatic downstream processing. In this example, the LLM is expected to be able to map column names of database tables to field labels in the electronic form based on orthographic or semantic considerations. When the column names or field labels deviate from such considerations, the LLM can be pretrained to learn the mapping to effect a retrieval-augmented generation process for producing the desired instructions.

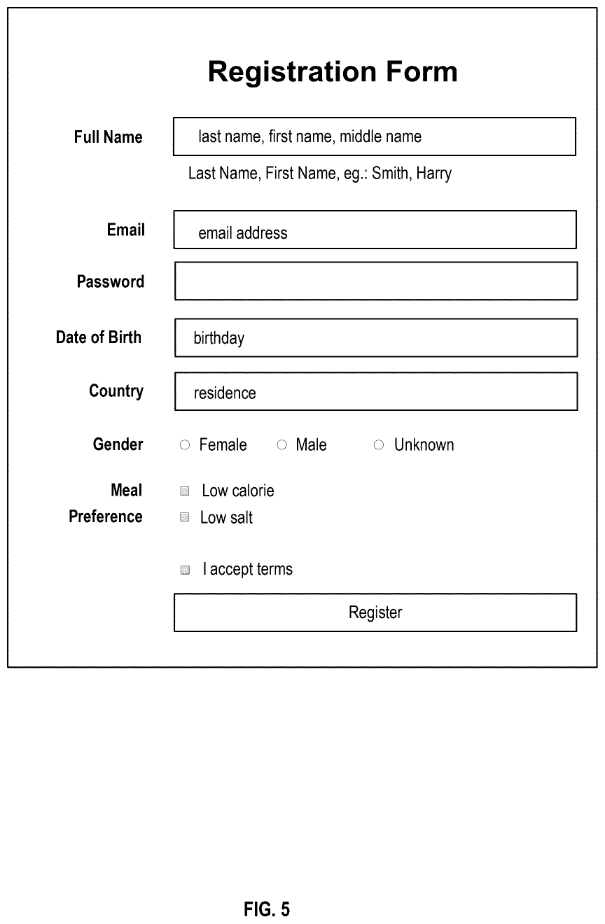

FIG. 4 illustrates an example portion of output data produced by an LLM regarding filling out an electronic form. In this example, the output data includes the statement 402 that identifies a field by the field label (“Full Name”) and instructs filling in the field in reference to the one or more metadata items (the value of the “last name” column followed by a comma followed by the value of the “first name” column). FIG. 5 illustrates another example portion of output data produced by an LLM regarding filling out an electronic form. In this example, the prompt can be designed to obtain a filled-out electronic form. Instead of simply associating a field with the field value, the output data produced by the LLM then represent the electronic form where each field value is placed in the field where possible.

In another example, the request can be finding a specific message in an email inbox associated with a user account. The request can include a particular query describing the subject matter of the specific message, such as “Adam's exchange with Bianca regarding Clive's new job”. In this example, the set of applications can include a local email agent and an external LLM. The local email agent can handle interfacing with a user device regarding the request and with an email server regarding email messages. The external LLM can handle digesting email messages and identifying any portion that matches a descriptive query. All the names and information regarding the new job or a portion thereof can be considered as sensitive data base on the access control rules. The original values of the sensitive data in the query and throughout the email inbox can then be replaced by obfuscated values. A prompt for the external LLM regarding finding the specific message in the email inbox can be designed to directly find the specific message. The output of the LLM can then be one or more messages that likely match the query, such as those in which Bianca said that she thought the new job was perfect for Clive but Adam thought that another job would be even better.

### 3.4. Restoring Input Data to Complete Tasks

In some embodiments, the server 102 is programmed to process the output data of the set of applications to complete the tasks based on the task specifications. The processing includes converting any obfuscated value into the original value based on the mapping discussed above. The server 102 can be programmed to identify each portion of the output data that corresponds to an obfuscated value, and determine an appropriate entry of the mapping for that portion of the output data to obtain the corresponding original value. As discussed above, this process can be performed based on the metadata stored within the mapping or separately in association with the output data, such as an email message or another document. When the input data to an LLM directly encodes signals indicating obfuscation, the process can also be performed directly based on the output data from the LLM. For example, each obfuscated value can have a prefix that indicates that it is an obfuscated value, and that prefix together with the rest of the obfuscated value can remain unaltered by the LLM.

In some embodiments, when the set of applications includes an LLM, the processing can depend on the prompt for the LLM that specifies how to generate the output data. When the prompt requests the LLM to generate instructions for performing the task, the server 102 is programmed to follow the instructions. For example, referring back to FIG. 4, the electronic form illustrated in FIG. 2 would be filled out by initially executing a database query using a known primary key, such a user account identifier, to retrieve values of the relevant columns based on the mapping. Subsequently, for instance, the “full name” field of the electronic form would be filled in by a string in the format indicated in the statement 402 composed of the values retrieved from the last name, first name, and middle name columns and punctuations. In this example, the instructions include requesting further input from the client device. Therefore, corresponding requests would be transmitted to the client device to obtain additional input, and the form would be filled out and submitted using the additional input and a programmatic selection of the Register button. When the prompt requests the LLM to partially perform the task, such as finding a message in an email inbox, a returned message that is then transformed based on the mapping is then ready without any instructions generated by an LLM to follow.

In some embodiments, the server 102 is programmed to perform additional processing specified in the request or according to the access control rules. The additional processing can include further formatting an original value given the type of access granted to the user account, such as showing only the last four digits of a social security number in a completed electronic form. The additional processing can also obfuscate or re-obfuscate all sensitive data in the output data of a ML model except for any data specified in the request. Alternatively, part of the additional processing requirement can be considered earlier in the process to leave certain obfuscated values intact and avoid converting them back to the original values and to the obfuscated values again. For example, when the request includes a query for finding a message that describes “Adam's exchange with Bianca regarding Clive's new job”, all sensitive data in a returned message, such as any remarks by Delia or any reference to a different job, can remain obfuscated or become newly obfuscated (e.g., when a digital item is accessible to the set of applications but not to the user account). The server 102 is programmed to then transmit the final result of performing the requested task to the client device as the source of the request.

### 4. Example Processes

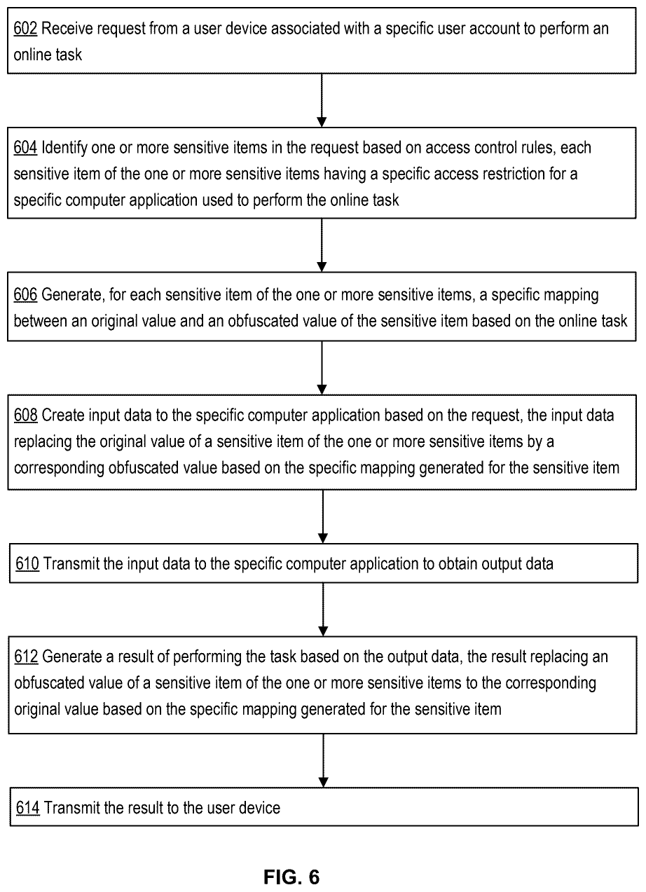

FIG. 6 illustrates a process of preserving data privacy in intelligent task performance in accordance with disclosed embodiments. FIG. 6 is shown in simplified, schematic format for purposes of illustrating a clear example and other embodiments may include more, fewer, or different elements connected in various manners. FIG. 6 is intended to disclose an algorithm, plan, or outline that can be used to implement one or more computer programs or other software elements which when executed cause performing the functional improvements and technical advances that are described herein. Furthermore, the flow diagrams herein are described at the same level of detail that persons of ordinary skill in the art ordinarily use to communicate with one another about algorithms, plans, or specifications forming a basis of software programs that they plan to code or implement using their accumulated skill and knowledge.

In step 602, the server 102 is programmed or configured to receive a request from a user device associated with a specific user account to perform an online task. In some embodiments, the online task includes interacting with a webpage or searching a database.

In some embodiments, the server 102 is programmed to obtain an access control rule of access control rules from a local database or based on the request. The access control rule being applicable to one or more of a user account, a group user account, an organization account, a data item, a document, a computer application, or a computer device.

In step 604, the server 102 is programmed or configured to identify one or more sensitive items in the request based on the access control rules. Each sensitive item of the one or more sensitive items has a specific access restriction for a specific computer application used to perform the online task. In some embodiments, the specific computer application includes an LLM, and the input data includes a prompt for the LLM to generate instructions for completing the online task or to partially complete the online task.

In step 606, the server 102 is programmed or configured to generate, for each sensitive item of the one or more sensitive items, a specific mapping between an original value and an obfuscated value of the sensitive item based on the online task. In some embodiments, the obfuscated value of the sensitive item of the one or more sensitive items includes random data, default data, approximate data, or corresponding metadata.

In some embodiments, generating the specific mapping comprises ranking obfuscation techniques by degree of obfuscation, speed of implementation, or nature of the online task. In certain embodiments, generating the specific mapping comprises determining that the online task can be performed using metadata of each sensitive item, and setting the obfuscated value of the sensitive item based on the metadata. In other embodiments, generating the specific mapping comprises determining that the online task relies on the one or more original values of the one or more sensitive items, and setting the obfuscated value of each sensitive item to be an encompassing range of the original value of the sensitive item. In yet other embodiments, the specific mapping for a sensitive item of the one or more sensitive items indicates a function for transformation between the original value and the obfuscated value of the sensitive item or identifying information of the sensitive item.

In step 608, the server 102 is programmed or configured to create input data to the specific computer application based on the request. The input data replaces the original value of a sensitive item of the one or more sensitive items by a corresponding obfuscated value based on the specific mapping generated for the sensitive item.

In some embodiments, the server 102 is programmed to obtain context data based on the request. The server 102 is programmed to then identify a set of sensitive items in the context data based on the access control rules. Each sensitive item of the set of sensitive items has a certain access restriction for the specific computer application. In addition, the server 102 is programmed to generate, for each sensitive item of the set of sensitive items, a certain mapping between an original value and an obfuscated value of the sensitive item based on the online task. The input data further replaces the original value of a sensitive item of the set of sensitive items by a corresponding obfuscated value based on the certain mapping generated for the sensitive item.

In step 610, the server 102 is programmed or configured to transmit the input data to the specific computer application to obtain output data.

In step 612, the server 102 is programmed or configured to generate a result of performing the task based on the output data. The result replaces an obfuscated value of a sensitive item of the one or more sensitive items to the corresponding original value based on the specific mapping generated for the sensitive item.

In some embodiment, the output data includes instructions for completing the task, and generating the result comprises following the instructions. In certain embodiments, the result further replaces an original value of a digital item by a specific obfuscated value based on the access control rules, where the digital item has a particular access restriction for the specific user account.

In step 614, the server 102 is programmed or configured to transmit the result to the user device.

### 5. Example Implementation

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

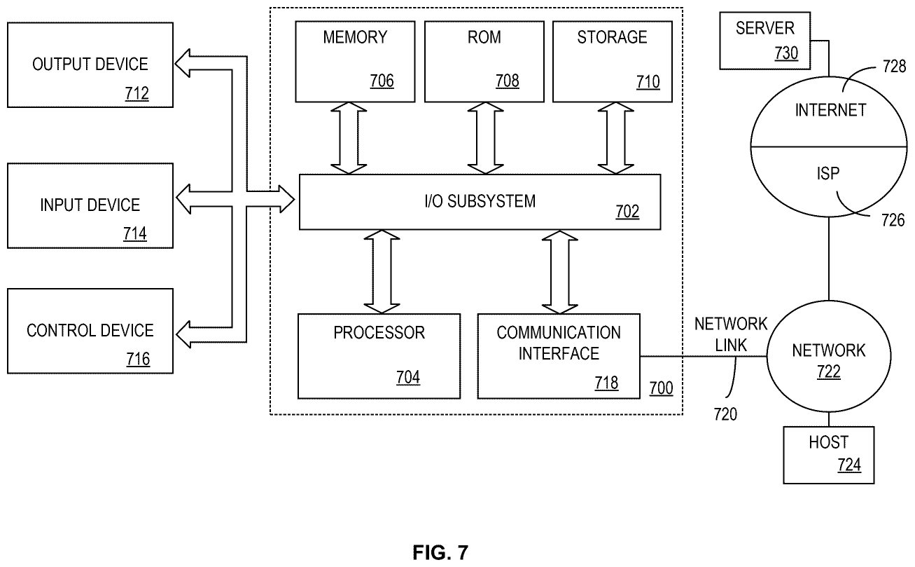

FIG. 7 illustrates an example computer system upon which various embodiments may be implemented. In the example of FIG. 7, a computer system 700 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 700 includes an input/output (I/O) subsystem 702 which may include a bus and/or other communication mechanism(s) for communicating information and/or instructions between the components of the computer system 700 over electronic signal paths. The I/O subsystem 702 may include an I/O controller, a memory controller and at least one I/O port. The electronic signal paths are represented schematically in the drawings, for example as lines, unidirectional arrows, or bidirectional arrows.

At least one hardware processor 704 is coupled to I/O subsystem 702 for processing information and instructions. Hardware processor 704 may include, for example, a general-purpose microprocessor or microcontroller and/or a special-purpose microprocessor such as an embedded system or a graphics processing unit (GPU) or a digital signal processor or Advanced RISC Machines (ARM) processor. Processor 704 may comprise an integrated arithmetic logic unit (ALU) or may be coupled to a separate ALU.

Computer system 700 includes one or more units of memory 706, such as a main memory, which is coupled to I/O subsystem 702 for electronically digitally storing data and instructions to be executed by processor 704. Memory 706 may include volatile memory such as various forms of random-access memory (RAM) or other dynamic storage device. Memory 706 also may be used for storing temporary variables or other intermediate information during execution of instructions to be executed by processor 704. Such instructions, when stored in non-transitory computer-readable storage media accessible to processor 704, can render computer system 700 into a special-purpose machine that is customized to perform the operations specified in the instructions.

Computer system 700 further includes non-volatile memory such as read only memory (ROM) 708 or other static storage device coupled to I/O subsystem 702 for storing information and instructions for processor 704. The ROM 708 may include various forms of programmable ROM (PROM) such as erasable PROM (EPROM) or electrically erasable PROM (EEPROM). A unit of persistent storage 710 may include various forms of non-volatile RAM (NVRAM), such as flash memory, or solid-state storage, magnetic disk, or optical disk such as CD-ROM or DVD-ROM, and may be coupled to I/O subsystem 702 for storing information and instructions. Storage 710 is an example of a non-transitory computer-readable medium that may be used to store instructions and data which when executed by the processor 704 cause performing computer-implemented methods to execute the techniques herein.

The instructions in memory 706, ROM 708 or storage 710 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement Transmission Control Protocol/Internet Protocol (TCP/IP), Hypertext Transfer Protocol (HTTP) or other communication protocols; file processing instructions to interpret and render files coded using HTML, XML, Joint Photographic Experts Group (JPEG), Moving Picture Experts Group (MPEG) or Portable Network Graphics (PNG); user interface instructions to render or interpret commands for a GUI, command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or NoSQL, an object store, a graph database, a flat file system or other data storage.

Computer system 700 may be coupled via I/O subsystem 702 to at least one output device 712. In one embodiment, output device 712 is a digital computer display. Examples of a display that may be used in various embodiments include a touch screen display or a light-emitting diode (LED) display or a liquid crystal display (LCD) or an e-paper display. Computer system 700 may include other type(s) of output devices 712, alternatively or in addition to a display device. Examples of other output devices 712 include printers, ticket printers, plotters, projectors, sound cards or video cards, speakers, buzzers or piezoelectric devices or other audible devices, lamps or LED or LCD indicators, haptic devices, actuators, or servos.

At least one input device 714 is coupled to I/O subsystem 702 for communicating signals, data, command selections or gestures to processor 704. Examples of input devices 714 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 716, which may perform cursor control or other automated control functions such as navigation in a graphical interface on a display screen, alternatively or in addition to input functions. Control device 716 may be a touchpad, a mouse, a trackball, or cursor direction keys for communicating direction information and command selections to processor 704 and for controlling cursor movement on the output device 712. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 714 may include a combination of multiple different input devices, such as a video camera and a depth sensor.

In another embodiment, computer system 700 may comprise an internet of things (IoT) device in which one or more of the output device 712, input device 714, and control device 716 are omitted. Or, in such an embodiment, the input device 714 may comprise one or more cameras, motion detectors, thermometers, microphones, seismic detectors, other sensors or detectors, measurement devices or encoders and the output device 712 may comprise a special-purpose display such as a single-line LED or LCD display, one or more indicators, a display panel, a meter, a valve, a solenoid, an actuator or a servo.

When computer system 700 is a mobile computing device, input device 714 may comprise a global positioning system (GPS) receiver coupled to a GPS module that is capable of triangulating to a plurality of GPS satellites, determining and generating geo-location or position data such as latitude-longitude values for a geophysical location of the computer system 700. Output device 712 may include hardware, software, firmware, and interfaces for generating position reporting packets, notifications, pulse or heartbeat signals, or other recurring data transmissions that specify a position of the computer system 700, alone or in combination with other application-specific data, directed toward host computer 724 or server 730.

Computer system 700 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 700 in response to processor 704 executing at least one sequence of at least one instruction contained in main memory 706. Such instructions may be read into main memory 706 from another storage medium, such as storage 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage 710. Volatile media includes dynamic memory, such as memory 706. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 702. Transmission media can also take the form of acoustic or light waves, such as those generated during radio-wave and infra-red data communications.

Various forms of media may be involved in carrying at least one sequence of at least one instruction to processor 704 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 700 can receive the data on the communication link and convert the data to be read by computer system 700. For instance, a receiver such as a radio frequency antenna or an infrared detector can receive the data carried in a wireless or optical signal and appropriate circuitry can provide the data to I/O subsystem 702 such as place the data on a bus. I/O subsystem 702 carries the data to memory 706, from which processor 704 retrieves and executes the instructions. The instructions received by memory 706 may optionally be stored on storage 710 either before or after execution by processor 704.

Computer system 700 also includes a communication interface 718 coupled to I/O subsystem 702. Communication interface 718 provides a two-way data communication coupling to network link(s) 720 that are directly or indirectly connected to at least one communication network, such as a network 722 or a public or private cloud on the Internet. For example, communication interface 718 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 722 broadly represents a LAN, WAN, campus network, internetwork, or any combination thereof. Communication interface 718 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 718 sends and receives electrical, electromagnetic, or optical signals over signal paths that carry digital data streams representing various types of information.

Network link 720 typically provides electrical, electromagnetic, or optical data communication directly or through at least one network to other data devices, using, for example, satellite, cellular, Wi-Fi, or BLUETOOTH technology. For example, network link 720 may provide a connection through a network 722 to a host computer 724.

Furthermore, network link 720 may provide a connection through network 722 or to other computing devices via internetworking devices and/or computers that are operated by an Internet Service Provider (ISP) 726. ISP 726 provides data communication services through a world-wide packet data communication network represented as internet 728. A server 730 may be coupled to internet 728. Server 730 broadly represents any computer, data center, virtual machine, or virtual computing instance with or without a hypervisor, or computer executing a containerized program system such as DOCKER or KUBERNETES. Server 730 may represent an electronic digital service that is implemented using more than one computer or instance and that is accessed and used by transmitting web services requests, Uniform Resource Locator (URL) strings with parameters in HTTP payloads, application programming interface (API) calls, app services calls, or other service calls. Computer system 700 and server 730 may form elements of a distributed computing system that includes other computers, a processing cluster, server farm or other organization of computers that cooperate to perform tasks or execute applications or services. Server 730 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to interpret or render files coded using HTML, XML, JPEG, MPEG or PNG; user interface instructions to render or interpret commands for a GUI, command-line interface or text user interface; application software such as an office suite, internet access applications, design and manufacturing applications, graphics applications, audio applications, software engineering applications, educational applications, games or miscellaneous applications. Server 730 may comprise a web application server that hosts a presentation layer, application layer and data storage layer such as a relational database system using SQL or NoSQL, an object store, a graph database, a flat file system or other data storage.

Computer system 700 can send messages and receive data and instructions, including program code, through the network(s), network link 720 and communication interface 718. In the Internet example, a server 730 might transmit a requested code for an application program through Internet 728, ISP 726, local network 722 and communication interface 718. The received code may be executed by processor 704 as it is received, and/or stored in storage 710, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 704. While each processor 704 or core of the processor executes a single task at a time, computer system 700 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

### 6. Extensions And Alternatives

In the foregoing specification, embodiments of the disclosure have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

________________________________________________

What is claimed is:

1. A method of preserving data privacy in intelligent task performance, comprising:
receiving a request from a user device associated with a specific user account to perform an online task;
identifying one or more sensitive items in the request based on access control rules,
each sensitive item of the one or more sensitive items having a specific access restriction for a specific computer application used to perform the online task;
generating, for each sensitive item of the one or more sensitive items, a specific mapping between an original value and an obfuscated value of the sensitive item based on the online task;
creating input data to the specific computer application based on the request,
the input data replacing the original value of a sensitive item of the one or more sensitive items by a corresponding obfuscated value based on the specific mapping generated for the sensitive item;
transmitting the input data to the specific computer application to obtain output data;
generating a result of performing the task based on the output data,
the result replacing an obfuscated value of a sensitive item of the one or more sensitive items to the corresponding original value based on the specific mapping generated for the sensitive item;
transmitting the result to the user device,
wherein the method is performed by one or more processors.

2. The method of claim 1, further comprising:
obtaining context data based on the request;
identifying a set of sensitive items in the context data based on the access control rules,
each sensitive item of the set of sensitive items having a certain access restriction for the specific computer application,
generating, for each sensitive item of the set of sensitive items, a certain mapping between an original value and an obfuscated value of the sensitive item based on the online task,
the input data further replacing the original value of a sensitive item of the set of sensitive items by a corresponding obfuscated value based on the certain mapping generated for the sensitive item.

3. The method of claim 1, further comprising
obtaining an access control rule of the access control rules from a local database or based on the request,
the access control rule being applicable to one or more of a user account, a group user account, an organization account, a data item, a document, a computer application, or a computer device.

4. The method of claim 1, the obfuscated value of the sensitive item of the one or more sensitive items including random data, default data, approximate data, or corresponding metadata.

5. The method of claim 1, generating the specific mapping comprising ranking obfuscation techniques by degree of obfuscation, speed of implementation, or nature of the online task.

6. The method of claim 1, generating the specific mapping comprising:
determining that the online task can be performed using metadata of each sensitive item;
setting the obfuscated value of the sensitive item based on the metadata.

7. The method of claim 1, generating the specific mapping comprising:
determining that the online task relies on the one or more original values of the one or more sensitive items;
setting the obfuscated value of each sensitive item to be an encompassing range of the original value of the sensitive item.

8. The method of claim 1, the specific mapping for a sensitive item of the one or more sensitive items indicating a function for transformation between the original value and the obfuscated value of the sensitive item or identifying information of the sensitive item.

9. The method of claim 1,
the specific computer application including a large language model (LLM),
the input data including a prompt for the LLM to generate instructions for completing the online task or to partially complete the online task.

10. The method of claim 1,
the output data including instructions for completing the task,
generating the result comprising following the instructions.

11. The method of claim 1,
the result further replacing an original value of a digital item by a specific obfuscated value based on the access control rules,
the digital item having a particular access restriction for the specific user account.

12. The method of claim 1, the online task including interacting with a webpage or searching a database.

13. A system for preserving data privacy in intelligent task performance, comprising:
a memory;
one or more processors coupled to the memory and configured to perform:
receiving a request from a user device associated with a specific user account to perform an online task;
identifying one or more sensitive items in the request based on access control rules,
each sensitive item of the one or more sensitive items having a specific access restriction for a specific computer application used to perform the online task;
generating, for each sensitive item of the one or more sensitive items, a specific mapping between an original value and an obfuscated value of the sensitive item based on the online task;
creating input data to the specific computer application based on the request,
the input data replacing the original value of a sensitive item of the one or more sensitive items by a corresponding obfuscated value based on the specific mapping generated for the sensitive item;
transmitting the input data to the specific computer application to obtain output data;
generating a result of performing the task based on the output data,
the result replacing an obfuscated value of a sensitive item of the one or more sensitive items to the corresponding original value based on the specific mapping generated for the sensitive item;
transmitting the result to the user device.

14. The system of claim 13, the one or more processors configured to further perform
obtaining an access control rule of the access control rules from a local database or based on the request,
the access control rule being applicable to one or more of a user account, a group user account, an organization account, a data item, a document, a computer application, or a computer device.

15. The system of claim 13, generating the specific mapping comprising ranking obfuscation techniques by degree of obfuscation, speed of implementation, or nature of the online task.

16. The system of claim 13, generating the specific mapping comprising:
determining that the online task can be performed using metadata of each sensitive item;
setting the obfuscated value of the sensitive item based on the metadata.

17. The system of claim 13, generating the specific mapping comprising:
determining that the online task relies on the one or more original values of the one or more sensitive items;
setting the obfuscated value of each sensitive item to be an encompassing range of the original value of the sensitive item.

18. The system of claim 13,
the specific computer application including an LLM,
the input data including a prompt for the LLM to generate instructions for completing the online task or to partially complete the online task.

19. The system of claim 13,
the result further replacing an original value of a digital item by a specific obfuscated value based on the access control rules,
the digital item having a particular access restriction for the specific user account.

20. One or more computer-readable, non-transitory storage media storing instructions for preserving data privacy in intelligent task performance, which when executed cause one or more processors to perform:
receiving a request from a user device associated with a specific user account to perform an online task;
identifying one or more sensitive items in the request based on access control rules,
each sensitive item of the one or more sensitive items having a specific access restriction for a specific computer application used to perform the online task;
generating, for each sensitive item of the one or more sensitive items, a specific mapping between an original value and an obfuscated value of the sensitive item based on the online task;
creating input data to the specific computer application based on the request,
the input data replacing the original value of a sensitive item of the one or more sensitive items by a corresponding obfuscated value based on the specific mapping generated for the sensitive item;
transmitting the input data to the specific computer application to obtain output data;
generating a result of performing the task based on the output data,
the result replacing an obfuscated value of a sensitive item of the one or more sensitive items to the corresponding original value based on the specific mapping generated for the sensitive item;
transmitting the result to the user device.
